(19) United States
(12) Patent Application Publication
(10) Pub. No.: US 2006/0260095 A1
(43) Pub. Date: Nov. 23, 2006

(54) Self locking hinge

(75) Inventors: Chuang-Hua Chueh, Hsin Chu City (TW); Chun-Min Wang, Shengang Township (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/436,629

(22) Filed: May 19, 2006

(30) Foreign Application Priority Data
May 23, 2005 (TW) 094116629

(51) Int. Cl. E05D 7/00

(52) U.S. Cl. 16/221

(57) ABSTRACT

A self locking hinge includes a driving element, a housing, a slider and a hooking part. The housing is pivotably mounted on the driving element and has an opening formed on a wall of the housing. The slider is movably disposed in the housing and always kept in contact with the driving element. The hooking part is disposed in the opening and may be moved out of or into the housing. The driving element moves the slider such that the slider presses against the hooking part and prevents the hooking part from being pushed back into the housing.

### BACKGROUND OF THE INVENTION

1. Field of the Invention

The invention relates to a self locking hinge, and more particularly to a self locking hinge having a slider for pressing against a hooking part to prevent the hooking part from being pushed back.

2. Description of the Related Art

The currently available scanners, copiers and multi-function peripherals in the market all need a hinge for a cover to be opened and closed. In order to consider the convenience in assembling the cover and the diversity of the to-be-scanned document, the cover is not usually firmly fixed onto a body through the hinge. Instead, the cover can be lifted up vertically through the hinge that is just inserted into the body. For example, when a book is being scanned, one end of the cover connected to the body may be slightly lifted up such that the cover, which is closed on the book with the specific thickness, is parallel to the scan platen and the scanned image with the high quality may be obtained. Thus, the cover may be easily separated from the body and fall down and crash or hurt someone when the scanner is being transported or when the scanner is not properly used.

In addition, when the cover is closed and the body is placed upside down, the cover tends to be separated from the body. Thus, when the scanner is being transported, the cover and the body tend to collide with each other to cause the damage.

### SUMMARY OF THE INVENTION

It is therefore an object of the invention to provide a self locking hinge, which may be applied to a scanner to prevent a closed cover of the scanner from being separated from a body of the scanner.

To achieve the above-identified object, the invention provides a self locking hinge including a driving element, a housing, a slider and a hooking part. The housing is pivotably mounted on the driving element and has an opening formed on a wall of the housing. The slider is movably disposed in the housing and always kept in contact with the driving element. The hooking part is disposed in the opening and may be moved out of or into the housing. The driving element can move the slider such that the slider presses against the hooking part to prevent the hooking part from being pushed back into the housing.

When the self locking hinge is applied to a scanner having a cover that is closed and a body, the cover cannot be separated from the body. When the cover is opened, the cover cannot be separated from the body. When a book is being scanned, the closed cover can be lifted up. Thus, the self locking hinge of the invention can satisfy the diversified demands of the users, and prevent the cover from being separated from the body.

### BRIEF DESCRIPTION OF THE DRAWINGS

FIG. 1 is a pictorial view showing an open state of a self locking hinge of the invention.

FIG. 2 is a pictorial view showing a close state of the self locking hinge of the invention.

FIG. 3 is a partially cross-sectional view showing the open state of the self locking hinge of the invention after the hooking part is moved into the housing by, for example, a tool.

FIG. 4 is a partially cross-sectional view showing the close state of the self locking hinge of the invention.

### DETAILED DESCRIPTION OF THE INVENTION

A self locking hinge of the invention will be described by taking a scanner as an example.

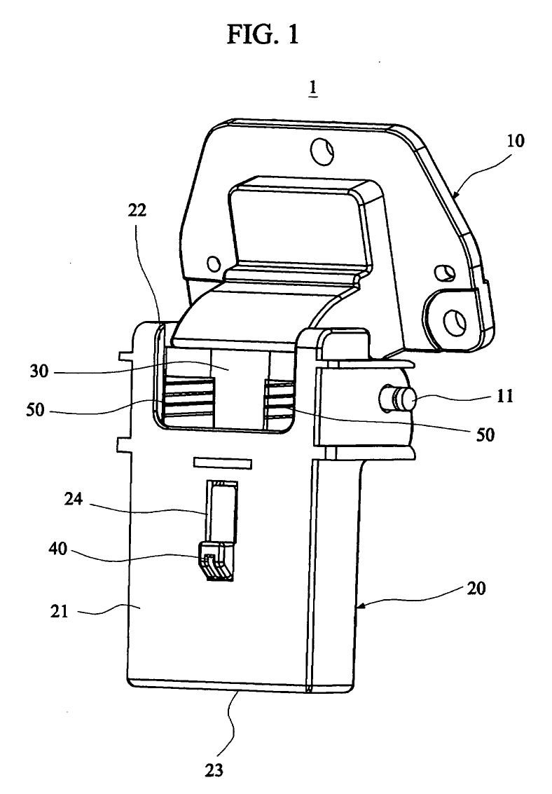

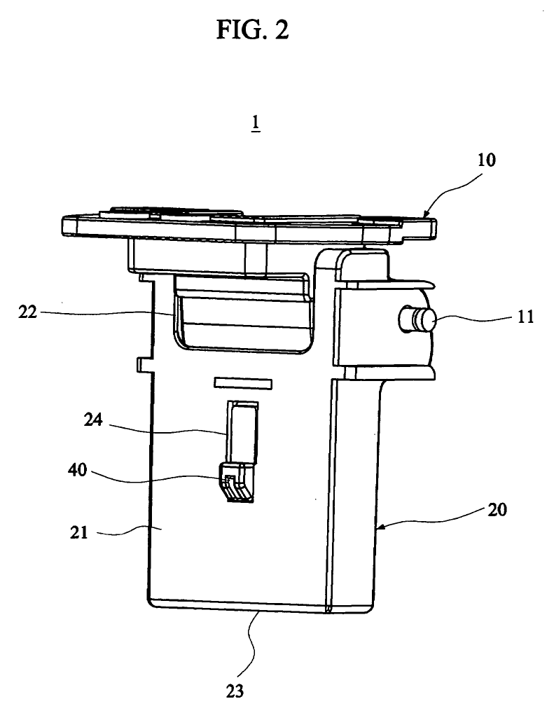

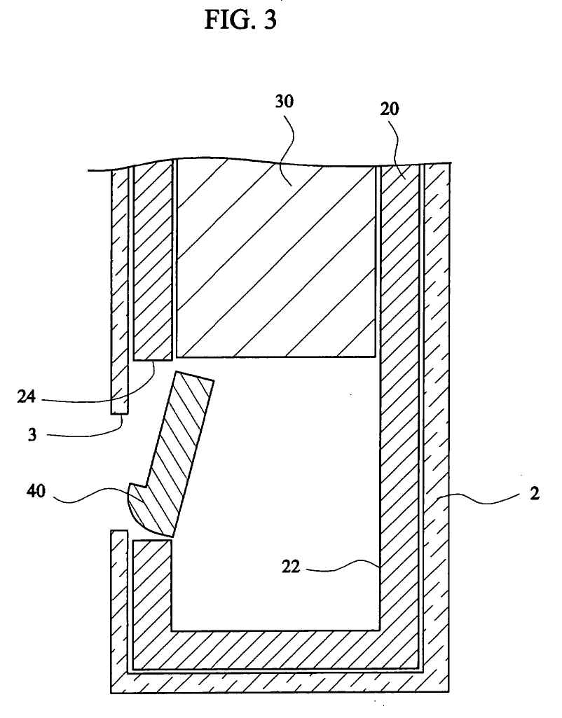

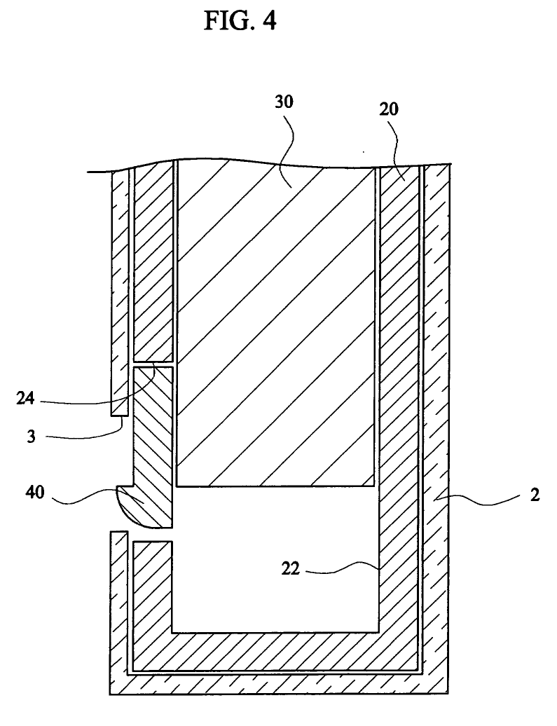

FIGS. 1 and 2 are pictorial views showing an open state and a close state of a self locking hinge 1 of the invention. FIGS. 3 and 4 are partially cross-sectional views showing the open and close states of the self locking hinge of the invention. As shown in FIG. 1, the self locking hinge 1 of the invention includes a driving element 10, a housing 20, a slider 30 and a hooking part 40. The driving element 10 is usually mounted on a cover (not shown) of the scanner. The housing 20 is usually mounted on a body 2 (FIGS. 3 and 4) of the scanner.

The housing 20 is pivotably mounted on the driving element 10 through a pivot 11. The housing 20 is formed with a guiding slot 22 and an opening 24 substantially vertically communicating with the guiding slot 22. The opening 24 is formed on a wall 21 of the housing 20. As shown in FIGS. 1 and 2, the wall 21 is a side surface of the housing 20 and is a vertical wall.

The guiding slot 22 extends in a direction parallel to a direction along which the housing 20 is inserted into the body 2 of the scanner. The slider 30 is movably disposed in the housing 20 and always kept in contact with the driving element 10. In this embodiment, the slider 30 is always kept in contact with the driving element 10 through two springs 50 contacting the housing 20. Thus, the driving element 10 and the slider 30 can apply a force to each other effectively. The two springs 50 are respectively located at both sides of the slider 30. Alternatively, the effect of the invention may also be achieved when only one spring 50 or even no spring is used. Alternatively, the slider and the driving element may be always kept in contact with each other according to the specially designed structures of the slider and the driving element, such as a combination of a form-closed cam and a follower.

The hooking part 40 is disposed in the opening 24. The hooking part 40 can be moved out of or into the housing 20. The driving element 10 can move the slider 30 such that the slider 30 presses against the hooking part 40 to prevent the hooking part 40 from being pushed back into the housing 20. For example, when the slider 30 is not pressed by the driving element 10, the hooking part 40 can be moved out of the housing 20 by a spring, its elasticity, a tool operated by the user, or an actuator, or can be moved into the housing 20 by the tool or another tool operated by the user or by the actuator or another actuator. When the driving element 10 presses the slider 30, the slider 30 presses against the hooking part 40 to prevent the hooking part 40 from being pushed back into the housing 20.

In this embodiment, when an angle between the driving element 10 and the housing 20 is substantially 90 degrees (i.e., when the cover of the scanner is closed on the body), the driving element 10 moves the slider 30 such that the slider 30 presses against the hooking part 40, as shown in FIGS. 2 and 4. In this case, the hooking part 40 is originally located in a slot 3 of the body 2, but the hooking part 40 is restricted by the slot 3 such that the housing 20 cannot be moved upwards again when the housing 20 is lifted up. In this case, when the cover of the scanner is closed, the cover and the body 2 cannot be separated from each other completely, and the cover is firmly connected to the body 2.

When an angle between the driving element 10 and the housing 20 is substantially greater than 145 degrees (or an angle ranging from 90 to 180 degrees according to the demand), that is, when the cover of the scanner is opened, the hooking part 40 can be moved into the housing 20 through the opening 24, as shown in FIGS. 1 and 3. That is, only when the cover is lifted up, the user can press the hooking part 40 into the housing 20 to disable the hooking part 40 from hooking the slot 3 of the body 2, such that the cover and the body 2 can be separated from each other completely.

Consequently, the cover cannot be completely separated from the body unintentionally when the cover is either closed or opened in the scanner using the self locking hinge. When a book is being scanned, the closed cover can be lifted up. Thus, the self locking hinge of the invention can satisfy the diversified demands of the users and prevent the cover from being separated from the body unintentionally.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A self locking hinge, comprising:
a driving element;
a housing, which is pivotably mounted on the driving element and has an opening formed on a wall of the housing;
a slider, which is movably disposed in the housing and always kept in contact with the driving element; and
a hooking part, which is disposed in the opening and may be moved out of or into the housing, wherein the driving element can move the slider such that the slider presses against the hooking part to prevent the hooking part from being pushed back into the housing.

2. The hinge according to claim 1, further comprising a spring, wherein the slider is always kept in contact with the driving element through the spring in contact with the housing.

3. The hinge according to claim 1, further comprising two springs, wherein the slider is always kept in contact with the driving element through the two springs in contact with the housing, and the two springs are respectively located at both sides of the slider.

4. The hinge according to claim 1, wherein when an angle between the driving element and the housing is substantially 90 degrees, the driving element moves the slider to make the slider press against the hooking part.

5. The hinge according to claim 1, wherein when an angle between the driving element and the housing is substantially greater than 145 degrees, the hooking part may be moved into the housing through the opening.

6. The hinge according to claim 1, wherein the wall is a vertical wall.
